(19) United States
(12) Patent Application Publication
(10) Pub. No.: US 2020/0157883 A1
(43) Pub. Date: May 21, 2020

(54) ADJUSTMENT MECHANISM FOR A ROLLER BLIND

(71) Applicant: ZMC Metal Coating Inc., Woodbridge (CA)

(72) Inventor: Philip Ng, Thornhill (CA)

(73) Assignee: ZMC Metal Coating Inc., Woodbridge (CA)

(21) Appl. No.: 16/550,449

(22) Filed: Aug. 26, 2019

Related U.S. Application Data
(60) Provisional application No. 62/770,420, filed on Nov. 21, 2018.

(51) Int. Cl. E06B 9/44; B65H 18/08

(52) U.S. Cl. CPC E06B 9/44; E06B 2009/402; B65H 18/08

(57) ABSTRACT

An adjustment mechanism for a roller blind. The adjustment mechanism comprises (i) an adjustment spring housing securable to an end plate of the roller blind such that when so secured the housing does not rotate independent of the end plate, (ii) a balancing spring coupler at least partially receivable within the adjustment spring housing, the balancing spring coupler having an outer end securable to an end of a balancing spring of the roller blind, (iii) an adjustment spring, the adjustment spring transferring rotational torque between the adjustment spring housing and the balancing spring coupler, and (iv) an adjustment shaft positioned at least partially within the adjustment spring housing. Rotation of the adjustment shaft causes a rotation of the balancing spring coupler and the adjustment spring relative to the adjustment spring housing to increase or decrease the torsional loading of the balancing spring.

### CROSS REFERENCE TO RELATED APPLICATIONS

This application claims priority on and the benefit of U.S. Provisional Patent Application No. 62/770,420 having a filing date of 21 Nov. 2018.

### TECHNICAL FIELD

This invention relates to the field of roller blinds, or roller shades as they are sometimes referred to.

### BACKGROUND OF THE INVENTION

Roller blinds are commonly installed about windows and other openings in a building to control or limit light intrusion, for sound dampening, and for aesthetic purposes.

Roller blinds may be constructed using a variety of different mechanical structures for the deployment and retraction of their blind material or fabric. In one instance, the blind's roller tube is fitted with an internal spring mechanism that permits the blind fabric to be deployed from the roller tube by merely grabbing the bottom of the fabric or a bottom bar and pulling downwardly to a desired position. The fabric is then maintained in that position until such time as the fabric is pulled in a downward direction again to release an internal locking mechanism which acts upon the spring, after which the spring causes the roller tube to turn in an opposite direction to re-wind the fabric back upon its exterior surface.

While roller blinds of such a structure have been successfully used for a considerable length of time, in some instances the ability of the internal spring structure to maintain the blind in a deployed position is challenged. This can particularly be the case in situations where the blind fabric is of a considerable length and/or weight. In such instances it is more difficult for the internal spring mechanism to balance the overall weight of a lengthy and/or wide and/or heavy blind fabric.

In reply, manufacturers of the blinds attempt to preload internal spring mechanisms to a sufficient degree that permits the spring to maintain the blind in a deployed position, without the blind slowly creeping downwardly under its considerable weight. However, manufacturers are challenged when attempting to preload an internal spring that is capable of both maintaining a large, heavy blind in a fully deployed state and also maintaining it in a state where it is only partially unwound from the roller tube. Further, in many instances the amount of torque to be placed upon the internal spring is left to an installer to determine through trial and error when the blind is mounted about a window frame. In such instances an installer is often required to climb up and down a ladder a number of times to make minor adjustments in the torque on the internal spring structure so that the blind can be “fine tuned” when installed.

### BRIEF SUMMARY OF THE INVENTION

The invention provides an adjustment mechanism for a roller blind, the adjustment mechanism comprising an adjustment spring housing securable to an end plate of the roller blind such that when so secured the housing does not rotate independent of the end plate, a balancing spring coupler at least partially receivable within the adjustment spring housing, the balancing spring coupler having an outer end securable to an end of a balancing spring of the roller blind, an adjustment spring, the adjustment spring transferring rotational torque between the adjustment spring housing and the balancing spring coupler, and an adjustment shaft positioned at least partially within the adjustment spring housing, wherein rotation of the adjustment shaft causes a rotation of the balancing spring coupler and the adjustment spring relative to the adjustment spring housing to thereby increase or decrease the torsional loading of the balancing spring.

The invention further provides an adjustment mechanism for a roller blind, the adjustment mechanism comprising an adjustment spring housing securable to an end plate of the roller blind such that when so secured the housing does not rotate independent of the end plate, a balancing spring coupler at least partially receivable within the adjustment spring housing, the balancing spring coupler having an outer end securable to an end of a balancing spring of the roller blind, an adjustment spring to transfer rotational torque between the adjustment spring housing and the balancing spring coupler, and an adjustment shaft positioned at least partially within the adjustment spring housing, the adjustment shaft including a radially outwardly extending arm that engages one of a pair of disposed ends of the adjustment spring upon rotation of the adjustment shaft such that rotation of the adjustment shaft causes an expansion of the adjustment spring to frictionally lock the balancing spring coupler to the adjustment spring housing causing the balancing spring coupler and the adjustment spring to rotate in relative unison with the rotation of the adjustment shaft and to thereby increase or decrease the torsional loading of the balancing spring.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper side perspective view of a roller blind constructed in accordance with an embodiment of the invention.

FIG. 2 is a left end view of the roller blind shown in FIG. 1.

FIG. 3 is a longitudinal sectional view taken along the line 3-3 of FIG. 2.

FIG. 4 is a vertical sectional view taken along the line 4-4 of FIG. 3.

FIG. 5 is a view similar to FIG. 1 showing the blind's primary components in an exploded arrangement.

FIG. 6 is an upper side perspective view of the end cap of the roller blind of FIG. 5.

FIG. 7 is a side elevational view of the end cap shown in FIG. 6.

FIG. 8 is a view similar to FIG. 6 showing an allen wrench received within the end cap for adjustment purposes.

FIG. 9 is an exploded view of the end cap shown in FIG. 6, together with the blind's balancing or torsion spring.

FIG. 10 is an outer end view of the end cap shown in FIG. 6.

FIG. 11 is a sectional view taken along the line 11-11 of FIG. 10.

FIG. 12 is a sectional view taken along the line 12-12 of FIG. 11.

FIG. 13 is a sectional view taken along the line 13-13 of FIG. 11.

FIG. 14 is a view similar to FIG. 12 wherein the adjustment shaft has been moved in a counter clockwise direction.

FIG. 15 is a view similar to FIG. 14 wherein the adjustment shaft has been moved in a clockwise direction.

FIG. 16 is a view similar to FIG. 13 wherein the roller tube has been rotated in a clockwise direction.

FIG. 17 is a view similar to FIG. 16 wherein the roller tube has been rotated in a counter clockwise direction.

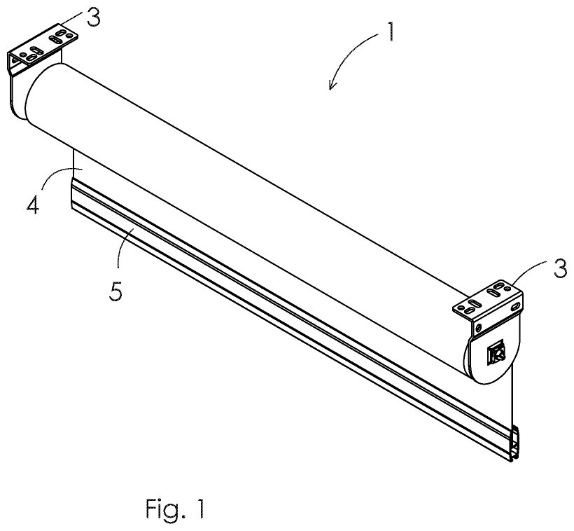

### DETAILED DESCRIPTION OF PREFERRED EMBODIMENTS

The present invention may be embodied in a number of different forms. The specification and drawings that follow describe and disclose some of the specific forms of the invention.

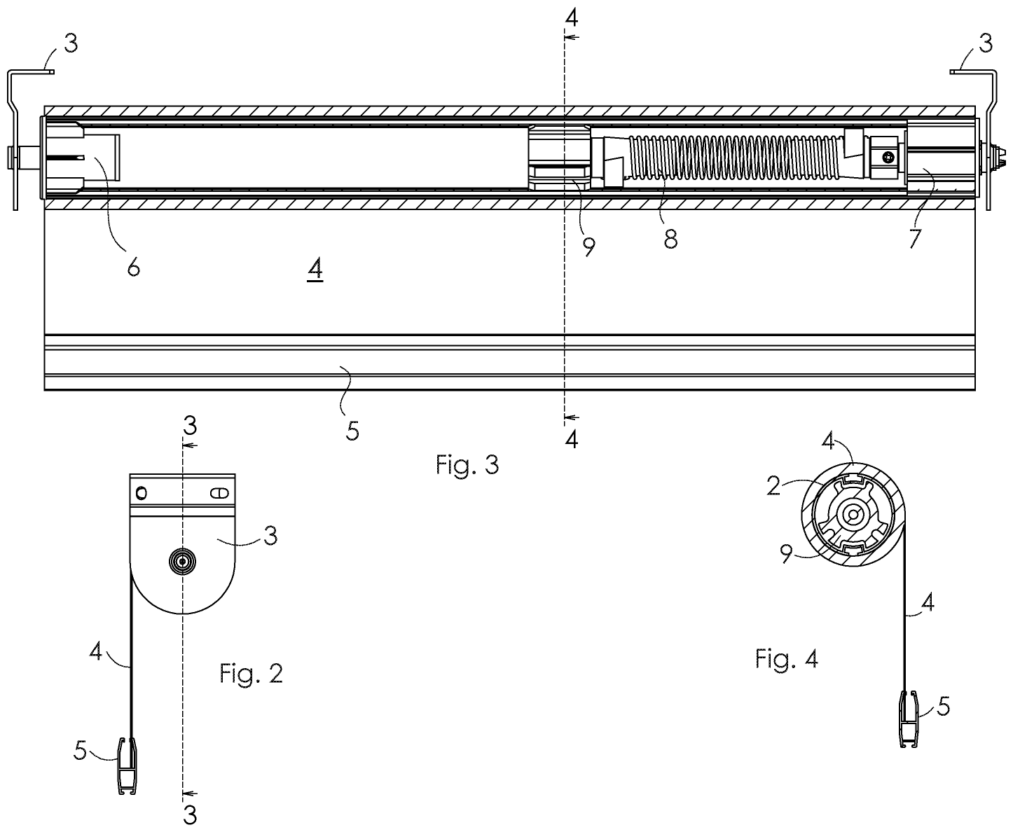

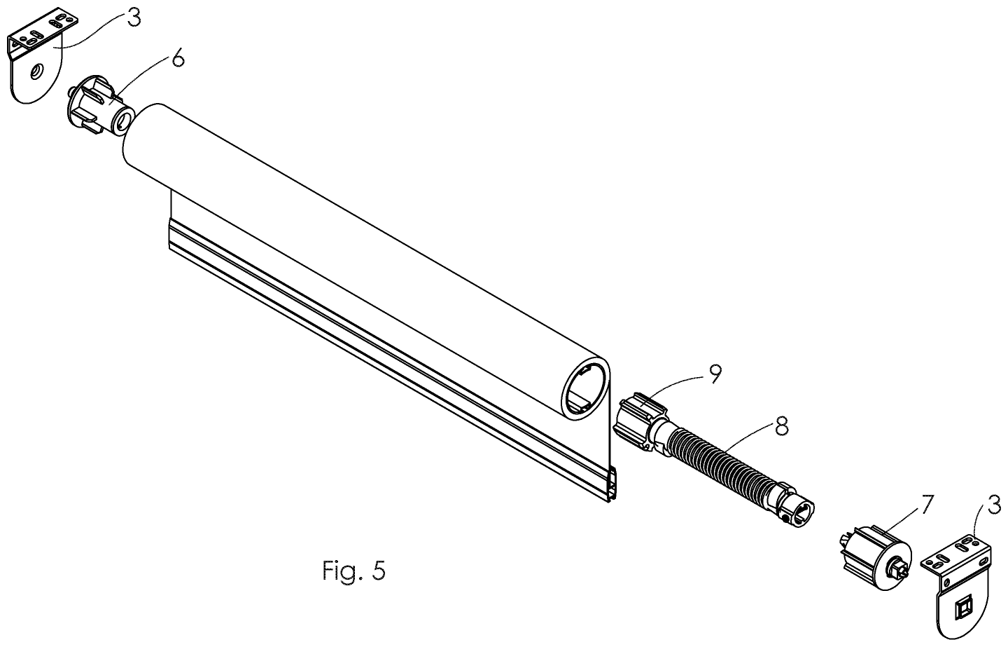

In the attached drawings there is shown a roller blind 1 that is comprised generally of a roller tube 2 mounted between a pair of end brackets 3. Blind fabric 4 is received about the roller tube and is secured to a bottom bar 5 along its lower edge. As shown in FIGS. 2 through 5, roller tube 2 is secured to end brackets 3 by means of an idle end cap 6 and an opposed drive end cap 7. As is common in roller blinds, idle end cap 6 mainly serves to secure one end of the roller tube to an end bracket, while permitting it to freely rotate. Similarly, drive end cap 7 secures the opposite end to the opposite end bracket, while at the same time housing at least a portion of the spring/drive/return mechanism. As in many roller blinds, the drive/return mechanism of roller blind 1 includes a balancing spring 8 having one end fixed to the interior of roller tube 1 by way of a balancing spring coupling 9.

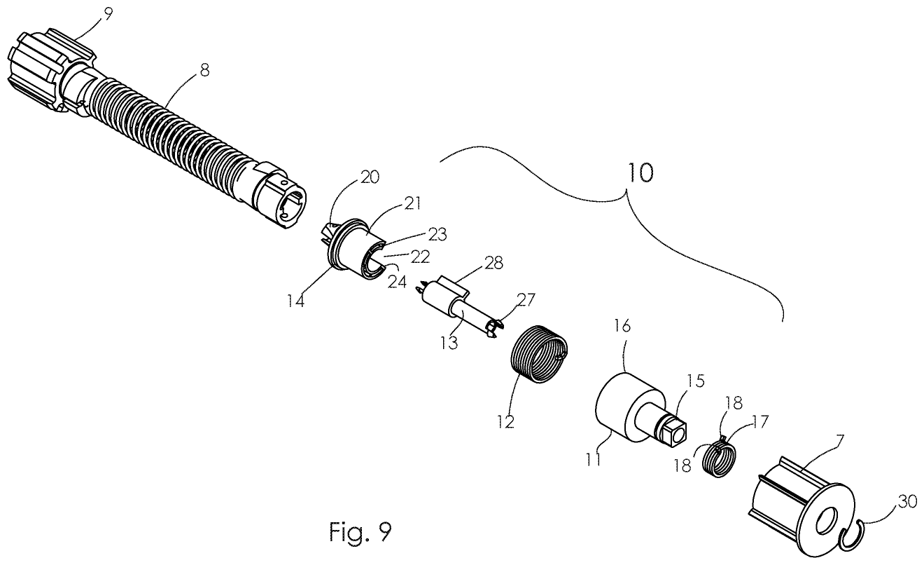

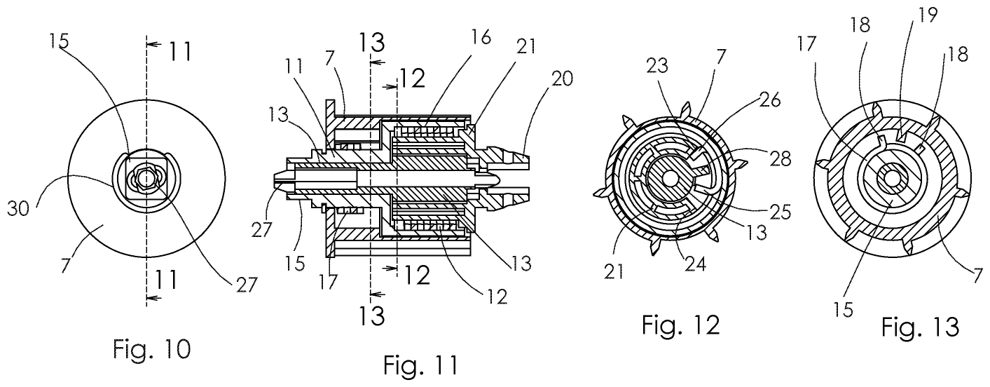

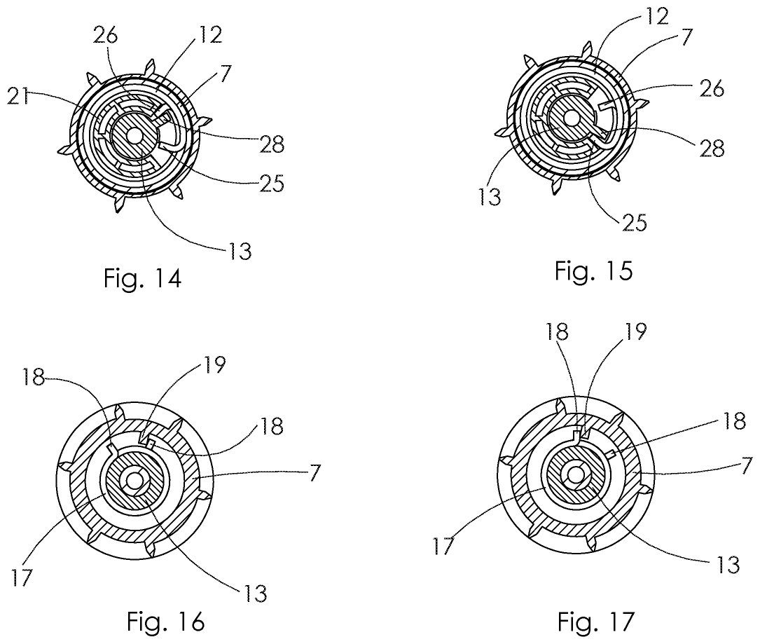

With particular reference to FIG. 9, in accordance with an embodiment of the invention there is provided an adjustment system 10 for roller blind 1. Adjustment mechanism 10 comprises, in general, an adjustment spring housing 11, an adjustment spring 12, an adjustment shaft 13, and a balancing spring coupler 14. Adjustment spring housing 11 is fixedly securable to an end bracket 3 of the roller blind such that when so secured the housing does not rotate relative to the end plate.

It will be appreciated that a wide variety of mechanisms and structures could be utilized to secure the adjustment spring housing to the end plate. Typically, adjustment spring housing 11 would include a shaft portion 15 and an enlarged barrel portion 16 having a generally hollow interior. In the assembled blind, adjustment spring housing 11 would be received within drive end cap 7 with shaft portion 15 extending outwardly through the end cap and secured to end bracket 3. In the particular embodiment depicted, the outer end of shaft portion 15 is generally square shaped such that it fits within a generally square shaped hole within the end bracket to effectively lock the two components together. A C-clip 30 or similar mechanical fastener can be used to prevent longitudinal movement between adjustment spring housing 11 and drive end cap 7. Further, as shown in the attached drawings, a housing spring 17 is received over the exterior surface of shaft portion 15 and is frictionally engaged therewith. Housing spring 17 is in the form of a helical spring having outer ends 18 that extend radially outward and that engage an inner rib 19 within the interior of drive end cap 7.

At least a portion of balancing spring coupler 14 is receivable within the hollow interior of barrel portion 16 of adjustment spring housing 11. Balancing spring coupler 14 includes an outer end 20 that can be secured to the end of balancing spring 8, opposite to balancing spring lock 9. In the embodiment shown in the attached drawings, balancing spring coupler further includes a generally cylindrical barrel 21 that is received within the interior bore of barrel portion 16 of adjustment housing 11. Barrel 21 may include a longitudinally oriented slot 22 forming a pair of engagement surfaces, 23 and 24 respectively.

Adjustment spring 12 is preferably received about the exterior surface of barrel portion 21 of balancing spring coupler 14 and within the hollow interior of barrel portion 16 of adjustment spring housing 11. From a thorough understanding of the invention it will be appreciated that adjustment spring 12 acts to transfer rotational torque between the adjustment spring housing and the balancing spring coupler. Adjustment spring 12 may be in the form of a helical torsion spring having a pair of inwardly directed ends 25 and 26. As will be described in further detail below, ends 25 and 26 engage engagement surfaces 23 and 24 on slot 22 during operation of the adjustment mechanism. In that manner, rotation of balancing spring coupler 14 will cause one of engagement surfaces 23 or 24 to come into contact with and act upon one of ends 25 and 26 of adjustment spring 12. The relative positions of ends 24 and 25 with respect to engagement surfaces 23 and 24 is such that the transference of rotational torque from balancing spring coupler 14 to one of ends 25 and 26 causes an enlargement of adjustment spring 12 to thereby help to “lock” the balancing spring coupler to the adjustment spring housing, and hence end bracket 3. That is, with the expansion of the diameter of adjustment spring 12 the frictional engagement between the outer surface of the adjustment spring and the inner surface of barrel portion 16 will be enhanced. It will further be appreciated that the nature of the described structure means that rotation of balancing spring coupler 14 in a first direction causes the engagement of one of engagement surfaces 23 and 24 with one of ends 25 and 26 and an enhancement of the frictional engagement of adjustment spring 12 and adjustment spring housing 11. Similarly, rotation of balancing spring coupler 14 in the opposite direction causes the other of the engagement surfaces 25 and 26 to once again cause an enhancement of the frictional engagement between the adjustment spring and the adjustment spring housing.

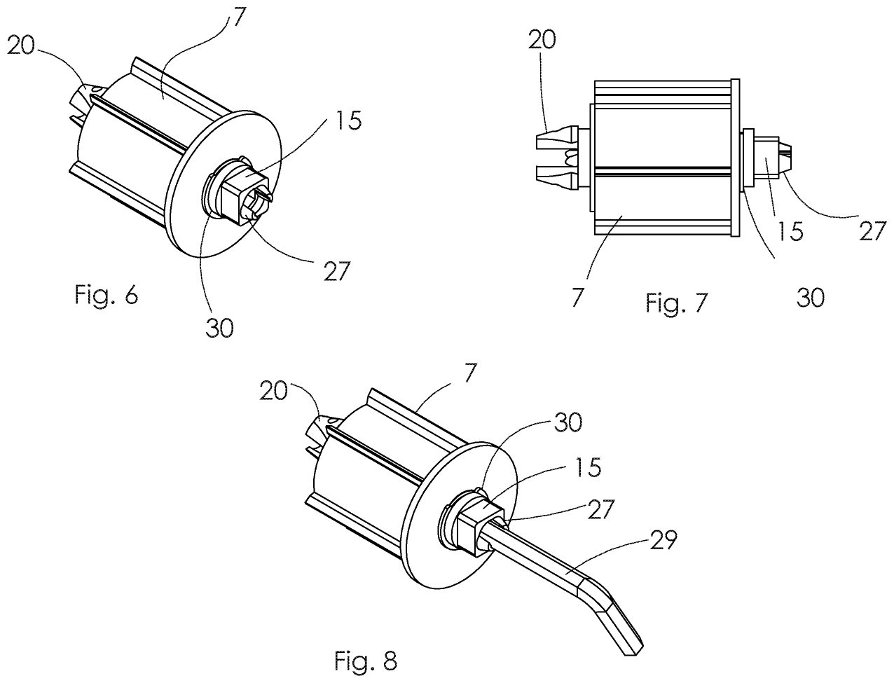

With reference again to FIG. 9, adjustment shaft 13 is positioned at least partially within adjustment spring housing 11 and has an outer end 27 that extends through adjustment spring housing 11 to permit a rotation of shaft 13 (see FIGS. 6-8). Adjustment shaft 13 also includes a radially outwardly extending arm 28 that, in the assembled adjustment mechanism, engages one of the inwardly disposed ends 24 and 25 of adjustment spring 12. It will thus be appreciated that through the use of a tool 29 (allen wrench, screwdriver, etc.) adjustment shaft 13 can be rotated in a clockwise or counter clockwise direction, thereby causing arm 28 to impart a clockwise or counter clockwise rotation of both adjustment spring 12 and balancing spring coupler 14 relative to adjustment spring housing 11. Rotation of the balancing spring coupler will thus cause either an increase or a decrease in the torsional loading of spring 8. Further, the rotational movement of adjustment spring 12 relative to adjustment spring housing 11 will effectively result in an alteration of the degree of torsional loading of balancing spring 8. Accordingly, through the use of tool 29 an installer can easily and quickly increase or decrease the pre-load of the balancing spring. Previously, balancing springs were preloaded during manufacturing of a roller blind. Only through disassembly of the blind on-site could an installer alter the pre-load on the balancing spring. The present invention thus provides the installer with a simplified and efficient method to alter the load on the balancing spring to accommodate roller blinds of differing lengths, blind fabric of different lengths, and blind fabrics of different weights.

In the described embodiment adjustment spring housing 11, balancing spring coupler 14, adjustment shaft 13, and adjustment spring 12 are at least partially (and preferably largely) received within drive end cap 7 such that the overall length of the roller tube is not extended. Maintaining the coupling structure effectively within drive end cap 7 and the interior of roller tube 2 helps to ensure that the blind fabric is not offset any further than necessary from the side of the window frame in order to help prevent light intrusion.

It is to be understood that what has been described are the preferred embodiments of the invention. The scope of the claims should not be limited by the preferred embodiments set forth above, but should be given the broadest interpretation consistent with the description as a whole.

I claim:

1. An adjustment mechanism for a roller blind, the adjustment mechanism comprising:
an adjustment spring housing securable to an end plate of the roller blind such that when so secured the housing does not rotate independent of the end plate;
a balancing spring coupler at least partially receivable within the adjustment spring housing, the balancing spring coupler having an outer end securable to an end of a balancing spring of the roller blind;
an adjustment spring, the adjustment spring transferring rotational torque between the adjustment spring housing and the balancing spring coupler; and
an adjustment shaft positioned at least partially within the adjustment spring housing, wherein rotation of the adjustment shaft causes a rotation of the balancing spring coupler and the adjustment spring relative to the adjustment spring housing to thereby increase or decrease the torsional loading of the balancing spring.

2. The adjustment mechanism as claimed in claim 1, wherein the adjustment spring is received within the adjustment spring housing and between an outer surface of the adjustment spring housing and a portion of the balancing spring coupler that is received within the adjustment spring housing.

3. The adjustment mechanism as claimed in claim 2, wherein the adjustment spring is a helical torsion spring.

4. The adjustment mechanism as claimed in claim 3, wherein the adjustment spring frictionally engages the interior surface of the adjustment spring housing.

5. The adjustment mechanism as claimed in claim 4, wherein the adjustment spring has a pair of inwardly disposed ends, the ends engaging the balancing spring coupler such that rotation of the balancing spring coupler causes an expansion of the adjustment spring to frictionally lock the balancing spring coupler to the adjustment spring housing.

6. The adjustment mechanism as claimed in claim 5, wherein the adjustment shaft includes a radially outwardly extending arm that engages one of the inwardly disposed ends of the adjustment spring upon rotation of the adjustment shaft.

7. The adjustment mechanism as claimed in claim 6, wherein the adjustment shaft includes an end extending through the adjustment spring housing and configured to be engaged by a tool for rotating the adjustment shaft.

8. The adjustment mechanism as claimed in claim 6, wherein the adjustment spring housing, the balancing spring coupler, the adjustment shaft, and the adjustment spring are at least partially received within a roller tube end cap of the roller blind.

9. The adjustment mechanism as claimed in claim 6, wherein the balancing spring coupler includes a generally cylindrical barrel received within a complementary shaped bore in the adjustment spring housing.

10. The adjustment mechanism as claimed in claim 9, wherein the barrel includes a longitudinally oriented slot forming a pair of engagement surfaces, upon rotation of the barrel in a first direction one of the engagement surfaces engaging one of the inwardly disposed ends of the adjustment spring, rotation of the barrel in a second opposite direction causing the other of the engagement surfaces to engage the other of the inwardly disposed ends of the adjustment spring.

11. An adjustment mechanism for a roller blind, the adjustment mechanism comprising:
an adjustment spring housing securable to an end plate of the roller blind such that when so secured the housing does not rotate independent of the end plate;
a balancing spring coupler at least partially receivable within the adjustment spring housing, the balancing spring coupler having an outer end securable to an end of a balancing spring of the roller blind;
an adjustment spring to transfer rotational torque between the adjustment spring housing and the balancing spring coupler; and
an adjustment shaft positioned at least partially within the adjustment spring housing, the adjustment shaft including a radially outwardly extending arm that engages one of a pair of disposed ends of the adjustment spring upon rotation of the adjustment shaft such that rotation of the adjustment shaft causes an expansion of the adjustment spring to frictionally lock the balancing spring coupler to the adjustment spring housing causing the balancing spring coupler and the adjustment spring to rotate in relative unison with the rotation of the adjustment shaft and to thereby increase or decrease the torsional loading of the balancing spring.

12. The adjustment mechanism as claimed in claim 11, wherein the adjustment shaft includes an end extending through the adjustment spring housing and configured to be engaged by a tool for rotating the adjustment shaft.

13. The adjustment mechanism as claimed in claim 11, wherein the adjustment spring housing, the balancing spring coupler, the adjustment shaft, and the adjustment spring are at least partially received within a roller tube end cap of the roller blind.

14. The adjustment mechanism as claimed in claim 11, wherein the balancing spring coupler includes a generally cylindrical barrel received within a complementary shaped bore in the adjustment spring housing, the barrel including a longitudinally oriented slot forming a pair of engagement surfaces, upon rotation of the barrel in a first direction one of the engagement surfaces engaging one of the ends of the adjustment spring, rotation of the barrel in a second opposite direction causing the other of the engagement surfaces to engage the other of the ends of the adjustment spring.
